(19) United States
(12) Patent Application Publication
(10) Pub. No.: US 2009/0232970 A1
(43) Pub. Date: Sep. 17, 2009

(54) METHOD OF MANUFACTURING EL ELEMENT AND METHOD OF MANUFACTURING EL PANEL

(75) Inventor: Takashi KIDU, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 12/401,794

(22) Filed: Mar. 11, 2009

(30) Foreign Application Priority Data
Mar. 12, 2008 (JP) 2008-062678
Dec. 26, 2008 (JP) 2008-334243

(51) Int. Cl. B05D 5/12

(52) U.S. Cl. 427/66

(57) ABSTRACT

Disclosed is a method of manufacturing an EL element. The EL element includes: a first electrode formed on a substrate; a carrier transport layer formed on the first electrode; a second electrode formed on the carrier transport layer; and a partition wall by which an opening is defined, the partition wall including a side wall in a longer direction of the opening and a side wall in a shorter direction of the opening, the opening being formed by surrounding the first electrode by the side wall in the longer direction and the side wall in the shorter direction. The method includes: moving a nozzle relatively along the shorter direction of the opening; and applying a liquid material, which is produced by dissolving or dispersing a material of the carrier transport layer in a solvent, to the first electrode in the opening by injecting the liquid material from the nozzle.

### BACKGROUND OF THE INVENTION

1. Field of the Invention

The present invention relates to a method of manufacturing an EL element and a method of manufacturing an EL panel.

2. Description of Related Art

Conventionally, in a process of manufacturing an EL element used for an EL (Electro Luminescence) display, a nozzle printing method of injecting a liquid EL material through a nozzle into a groove between partition walls which are formed so as to surround a transparent electrode provided on a glass substrate is known as a step of forming a carrier transport layer (See Japanese Patent Application Laid-Open Publication No. 2002-75640).

However, in a process of drying the EL material applied between the partition walls to form a carrier transport layer, a raised film forming layer called “soaking” resulted from film formation of the EL material adhered to the partition wall face is generated. Soaking is a phenomenon in which ink is soaked up by capillary action. It may deteriorate uniformity of the film thickness of the carrier transport layer, and unevenness in light emission may be caused by non-uniform film thickness.

### SUMMARY OF THE INVENTION

It is, therefore, a main object of the present invention to reduce nonuniformity in film thickness of a carrier transport layer.

According to a first aspect of the present invention, there is provided a method of manufacturing an EL element, the EL element including: a first electrode formed on a substrate; a carrier transport layer formed on the first electrode; a second electrode formed on the carrier transport layer; and a partition wall by which an opening is defined, the partition wall including a side wall in a longer direction of the opening and a side wall in a shorter direction of the opening, the opening being formed by surrounding the first electrode by the side wall in the longer direction and the side wall in the shorter direction, and the method including: moving a nozzle relatively along the shorter direction of the opening; and applying a liquid material, which is produced by dissolving or dispersing a material of the carrier transport layer in a solvent, to the first electrode in the opening to produce an applied liquid material by injecting the liquid material from the nozzle.

Preferably, the liquid material is further applied onto a top surface of the side wall in the longer direction, the side wall being adjacent to the opening along the shorter direction, Preferably, the carrier transport layer includes a light emission layer for emitting light and a carrier injection layer for injecting a carrier into the light emission layer, and in the step of applying the liquid material, the liquid material which is produced by dissolving or dispersing a material of at least the carrier injection layer in a solvent, is applied to the first electrode.

Preferably, the carrier transport layer includes a light emission layer for emitting light and a carrier injection layer for injecting a carrier in to the light emission layer, the carrier injection layer is formed by a non-wet film forming method, and the light emission layer is formed in the step of applying the liquid material.

Preferably, the method further includes: drying the applied liquid material after the step of applying the liquid material.

Preferably, the method, further includes: forming the second electrode covering the carrier transport layer and the partition wall after the step of drying the applied liquid material.

Preferably, in the step of applying the liquid material, the liquid material is applied by a nozzle printing method.

Preferably, in the step of applying the liquid material, the liquid material is applied by an ink-jet method, According to a second aspect of the present invention, there is provided a method of manufacturing an EL panel having partition walls by which a plurality of electrodes on a substrate are surrounded, a plurality of openings being defined by the partition walls, each of the partition walls including a side wall in a longer direction of each opening and a side wall in a shorter direction of each opening, each opening being formed by surrounding each electrode by the side wall in the longer direction and the side wall in the shorter direction, and the method including: moving a nozzle relatively along a line of the openings arranged in the shorter direction; and continuously applying a liquid material, which is produced by dissolving or dispersing a material of a carrier transport layer in a solvent, to the plurality of the openings to produce an applied liquid material by injecting the liquid material from the nozzle.

Preferably, the carrier transport layer includes a light emission layer for emitting light and a carrier injection layer for injecting a carrier into the light emission layer, and in the step of applying the liquid material, the liquid material which is produced by dissolving or dispersing a material of at least the carrier injection layer in a solvent, is applied.

Preferably, the carrier transport layer includes a light emission layer for emitting light and a carrier injection layer for injecting a carrier in to the light emission layer, the carrier injection layer is formed by a non-wet film forming method, and the light emission layer is formed in the step of applying the liquid material.

Preferably, the liquid material is not applied onto top surfaces of the partition walls between the openings which are adjacent along the longer direction.

Preferably, the liquid material is further applied onto a top surface of the side wall in the longer direction between the openings.

Preferably, the method further includes: drying the applied liquid material after the step of applying the liquid material.

Preferably, the method further includes: forming a second electrode covering the carrier transport layer and the partition walls after the step of drying the applied liquid material.

Preferably, in the step of applying the liquid material, the liquid material is applied by a nozzle printing method.

Preferably, in the step of applying the liquid material, the liquid material is applied by an ink-jet method.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a plan view showing a layout of pixels on an EL panel according to preferred embodiments of the present invention;

FIG. 2 is a plan view showing a schematic configuration of the EL panel;

FIG. 3 shows a circuit diagram corresponding to one pixel on the EL panel;

FIG. 4 is a plan view showing one pixel on the EL panel;

FIG. 5 is a cross-sectional view taken along line V-V of FIG. 4;

FIG. 6 is a cross-sectional view taken along line VI-VI of FIG. 4;

FIG. 7 is a cross-sectional view showing an opening of a bank of the EL panel;

FIG. 8 is a cross-sectional view showing a hole injection layer formed in the opening;

FIG. 9 is a cross-sectional view showing the hole injection layer and a light emission layer formed in the opening;

FIG. 10 is an explanatory diagram showing a step of continuously applying a liquid material by relatively moving a nozzle along a shorter direction of the openings which are approximately rectangular in shape;

FIG. 11 is an explanatory diagram showing that a liquid material is continuously applied along a line of recesses of openings, each of which has an approximately square shape;

FIG. 12 is an enlarged view showing a carrier transport layer formed in the opening having an approximately square shape;

FIG. 13 is an explanatory diagram showing a measurement result of thickness of the carrier transport layer formed in the opening having an approximately square shape;

FIG. 14 is a diagram for explaining “soaking” in the opening which is approximately rectangular in shape;

FIG. 15 is a diagram for explaining measurement of thickness of the carrier transport layer formed in the opening which is rectangular in shape;

FIG. 16 is an explanatory diagram showing a measurement result of thickness of the carrier transport layer formed in the opening which is rectangular in shape, and

FIG. 17 is a cross-sectional view showing that a liquid material is continuously applied from a nozzle by an ink jet method.

### PREFERRED EMBODIMENTS OF THE INVENTION

Preferred embodiments for carrying out the present invention will be described below with reference to the drawings. In the following embodiments, various limitations which are technically preferable to carry out the invention will be described. However, the scope of the present invention is not limited to the following embodiments and the drawings.

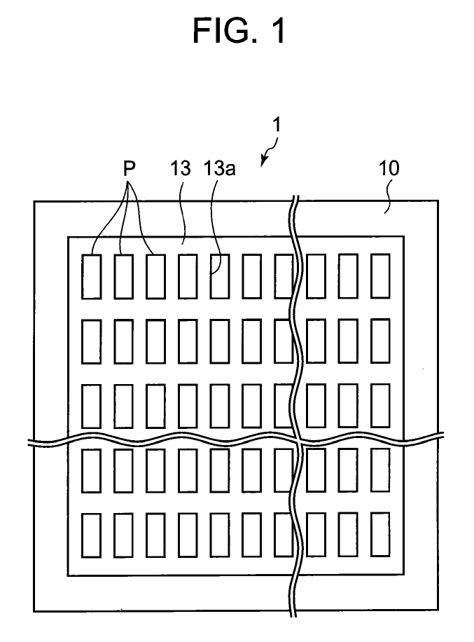

FIG. 1 is a plan view showing a layout of a plurality of pixels P on an EL panel 1. FIG, 2 is a plan view showing a schematic configuration of the EL panel 1.

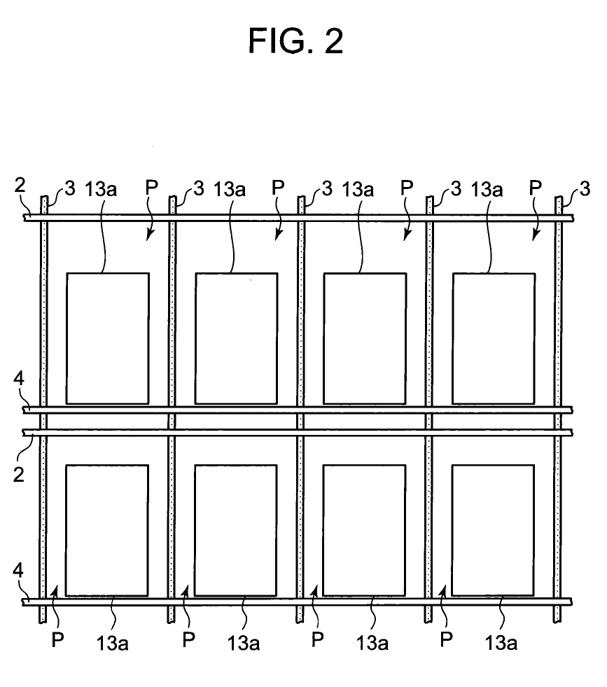

As shown in FIGS. 1 and 2 in the EL panel 1, the plurality of pixels P each emitting light of R (red), G (green), and B (blue) are arranged in a matrix in a predetermined pattern.

In the EL panel 1, a plurality of scan lines 2 are provided approximately in parallel with each other in the row direction, and a plurality of signal lines 3 are provided approximately in parallel with each other in the column direction so as to be approximately orthogonal to the scan lines 2 in plan view. A voltage supply line 4 is provided along each of the scan lines 2 between neighboring scan lines 2. A pixel P corresponds to a range surrounded by each scan line 2 two adjacent signal lines 3, and each voltage supply line 4.

The EL panel 1 is also provided with a bank 13 as partition walls in a lattice-like arrangement so that the bank 13 can cover the scan lines 2, the signal lines 3, and the voltage supply lines 4. A plurality of approximately rectangular-shaped openings 13a surrounded by the bank 13 are formed for each of the pixels P. A predetermined carrier transport layer (a hole injection layer 8b and a light emission layer 8c which will be described later) is provided in the opening 13a and serves as a light emission region in the pixel P. The carrier transport layer is a layer for transporting positive holes or electrons when voltage is applied.

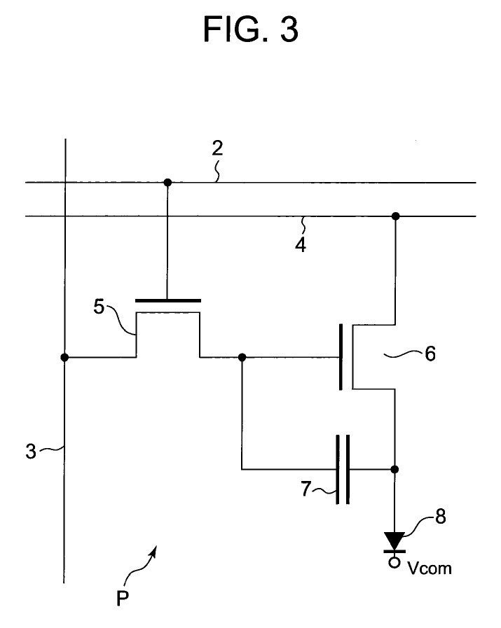

FIG. 3 shows a circuit diagram corresponding to one pixel on the EL panel 1 which operates by an active matrix driving method.

As shown in FIG. 3, the EL panel 1 is provided with the scan line 2, the signal line 3 crossing the scan line 2, and the voltage supply line 4 extending along the scan line 2. Per pixel P in the EL panel 1, a switch transistor 5 as a thin film transistor, a drive transistor 6 as a thin film transistor, a capacitor 7, and an EL element 8 are provided.

For each pixel P, the gate of the switch transistor 5 is connected to the scan line 2, one of the drain and source of the switch transistor 5 is connected to the signal line 3, and the other of the drain and source of the switch transistor 5 is connected to one of electrodes of the capacitor 7 and the gate of the drive transistor 6. One of the source arid drain of the drive transistor 6 is connected to the voltage supply line 4, and the other of the source and drain of the drive transistor 6 is connected to the other electrode of the capacitor 7 and the anode of the EL element 8. The cathodes of the EL elements 8 of all of the pixels P are maintained at predetermined voltage V com (for example, grounded).

In the periphery of the EL panel 1, the scan lines 2 are connected to a scan driver, the voltage supply lines 4 are connected to a predetermined voltage source or a driver for properly outputting a voltage signal, and the signal lines 3 are connected to a data driver. By the drivers, the EL panel 1 is driven by the active matrix driving method, A predetermined power is supplied from the constant voltage source or the driver to the voltage supply lines 4.

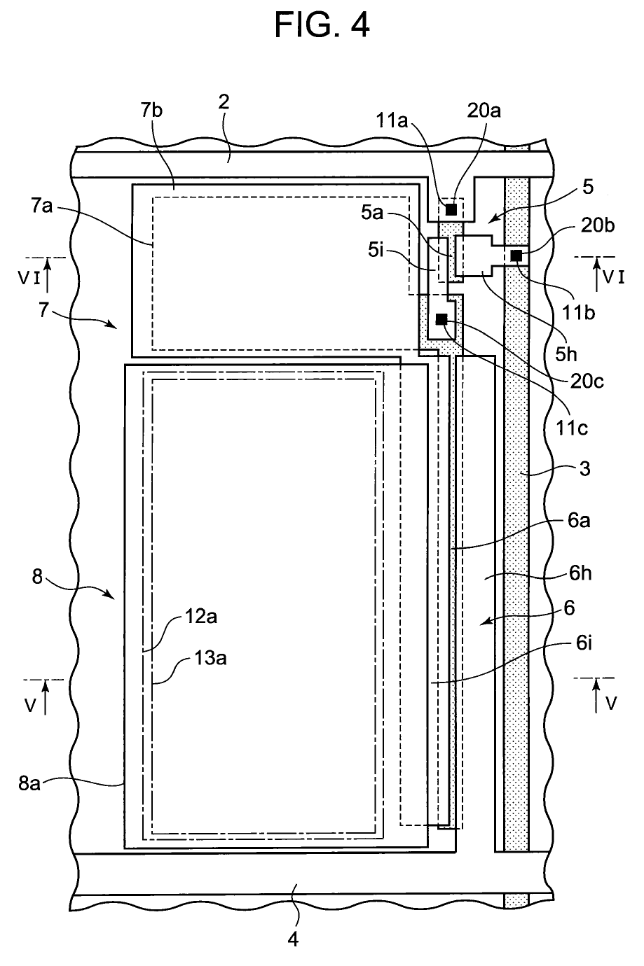

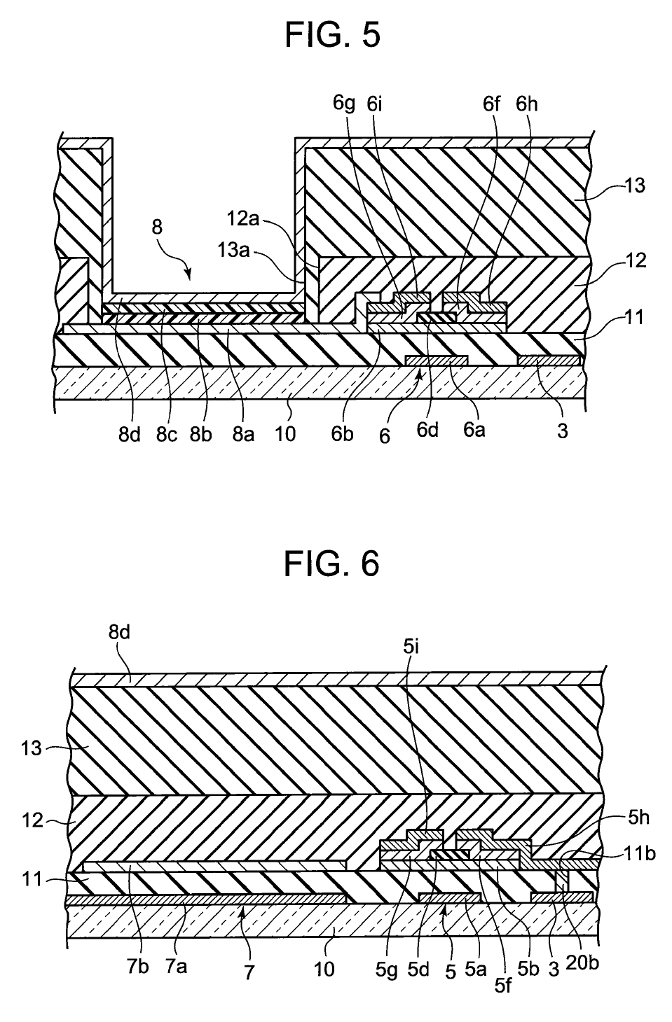

The circuit structure of the EL panel 1 and the pixel P in the EL panel 1 will now be described with reference to FIGS. 4 to 6. FIG. 4 is a plan view corresponding to one pixel P on the EL panel 1. FIG. 5 is a cross-sectional view taken along line V-V of FIG. 4. FIG. 6 is across-sectional view taken along line VI-VI, In FIG. 4, electrodes and wires are mainly shown.

As shown in FIG. 4, the switch transistor 5 and the drive transistor 6 are arranged so as to extend along the signal line 3, the capacitor 7 is disposed near the switch transistor 5, and the EL element 8 is disposed near the drive transistor 6. Between the scan line 2 and the voltage supply line 4, the switch transistor 5, the drive transistor 6, the capacitor 7, and the EL element 8 are disposed.

As shown in FIGS. 4 to 6, an interlayer insulating film 11 as a gate insulating film is formed on a surface of a substrate 10, and an interlayer insulating film 12 is formed on the interlayer insulating film 11. The signal line 3 is formed between the interlayer insulating film 11 and the substrate 10, and the scan line 2 and the voltage supply line 4 are formed between the interlayer insulating films 11 and 12.

As shown in FIGS. 4 and 6, the switch transistor 5 is a thin film transistor having an inversely-staggered structures The switch transistor 5 has a gate 5a, a semiconductor film 5b, a channel protection film 5d, impurity semiconductor films 5f and 5g, a drain electrode 5h, a source electrode 5i and the like.

The gate 5a is formed between the substrate 10 and the interlayer insulating film 11. The gate 5a is made of, for example, a Cr film, an Al film, a Cr/Al stack film, an AlTi alloy film, or an AlTiNd alloy film. The interlayer insulating film 11 having insulation properties is formed on the gate 5a. The gate 5a is covered with the interlayer insulating film 11.

The interlayer insulating film 11 is made of, for example, silicon nitride or silicon oxide. The intrinsic semiconductor film 5b is formed on the interlayer insulating film 11 and in a position corresponding to the gate 5a. The semiconductor film 5b and the gate 5a are opposed while sandwiching the interlayer insulating film 11.

The semiconductor film 5b is made of, for example, amorphous silicon or polycrystal silicon. A channel is formed in the semiconductor film 5b. The channel protection film 5d having insulation properties is formed on a center portion in the semiconductor film 5b. The channel protection film 5d is made of, for example, silicon nitride or silicon oxide.

The impurity semiconductor film 5f is formed so as to partially overlap the channel protection film 5b on an end of the semiconductor film 5b, and the impurity semiconductor film 5g is formed so as to partially overlap the channel protection film 5d on the other end of the semiconductor film 5b. The impurity semiconductor films 5f and 5g are formed at both ends of the semiconductor film 5b so as to be apart from each other. Although the impurity semiconductor films 5f and 5g are made of n-type semiconductor, they may be made of p-type semiconductor

On the impurity semiconductor film 5f, the drain electrode 5h is formed. On the impurity semiconductor film 5g, the source electrode Si is formed The drain electrode 5h and the source electrode 5i are made of, for example, a Cr film, an Al film, a Cr/Al stack film, an AlTi alloy film, or an AlTiNd alloy film.

On the channel protection film 5d, the drain electrode 5h, and the source electrode 5i, the interlayer insulating film 12 having insulation properties and becoming a protection film is formed. The channel protection film 5d, the drain electrode 5b, and the source electrode 5i are covered with the interlayer insulating film 12. The switch transistor 5 is covered with the interlayer insulating film 12. The interlayer insulating film 12 has, for example, a thickness of 100 nm to 200 nm and is made of silicon nitride or silicon oxide.

As shown in FIGS. 4 and 5, the drive transistor 6 is a thin film transistor having an inversely-staggered structure, The drive transistor 6 has a gate 6a, a semiconductor film 6b, a channel protection film 6d, impurity semiconductor films 6f and 6g, a drain electrode 6h, a source electrode 6i and the like.

The gate 6a is made of, for example, a Cr film, an Al film a Cr/Al stack film, an AlTi alloy film, or an AlTiNd alloy film and is formed between the substrate 10 and the interlayer insulating film 11 like the gate 5a. The gate 6a is covered with the interlayer insulating film 11 made of, for example, silicon nitride or silicon oxide.

The semiconductor film 6b in which a channel is formed in a position corresponding to the gate 6a on the interlayer insulating film 11 is made of, for example, amorphous silicon or polycrystal silicon. The semiconductor film 6b faces the .gate 6a over the interlayer insulating film 11

The channel protection film 6d having insulation properties is formed on a center portion in the semiconductor film 6b. The channel protection film 6d is made of, for example, silicon nitride or silicon oxide.

The impurity semiconductor film 6f is formed so as to partially overlap the channel protection film 6d on an end of the semiconductor film 6b, and the impurity semiconductor film 6g is formed so as to partially overlap the channel protection film 6d on the other end of the semiconductor film 6b. The impurity semiconductor films 6f and 6g are formed at both ends of the semiconductor film 6b so as to be apart from each other. Although the impurity semiconductor films 6f and 6g are made of n-type semiconductor, they may be made of p-type semiconductor.

On the impurity semiconductor film 6f, the drain electrode 6h is formed. On the impurity semiconductor film 6g, the source electrode 6i is formed. The drain electrode 6h and the source electrode 6i are made of, for example, a Cr film, an Al, film, a Cr/Al stack film, an AlTi alloy film, or an AlTiNd alloy film.

On the channel protection film 6d, the drain electrode 6h, and the source electrode 6i, the interlayer insulating film 12 having insulation properties is formed. The channel protection film 6d, the drain electrode 6h, and the source electrode 6i are covered with the interlayer insulating film 12.

The capacitor 7 is connected between the gate electrode 6a and the source electrode 6i of the drive transistor 6. As shown in FIGS, 4 and 6, an electrode 7a is formed between the substrate 10 and the interlayer insulating film 11, and the other electrode 7b is formed between the interlayer insulating films 11 and 12. The electrodes 7a and 7b are opposed while sandwiching the interlayer insulating film 11 as a dielectric.

The signal line 3, the electrode 7a of the capacitor 7, the gate 5a of the switch transistor 5, and the gate 6a of the drive transistor 6 are formed in a lump by processing a conductive film formed on the surface of the substrate 10 by photo lithography, etching, or the like.

The scan line 2, the voltage supply line 4, the electrode 7b of the capacitor 7, the drain electrode 5h and the source electrode 5i of the switch transistor 5, and the drain electrode 6h and the source electrode 6i of the drive transistor 6 are formed by processing a conductive film formed on the surface of the interlayer insulating film 11 by photolithography, etching, or the like.

In the interlayer insulating film 11, a contact hole 11a is formed in a region where the gate electrode 5a and the scan line 2 overlap, a contact hole 11b is formed in a region where the drain electrode 5h and the signal line 3 overlap, a contact hole 11c is formed in a region where the gate electrode 6a and the source electrode 5i overlap, and contact plugs 20a to 20c are buried in the contact holes 11a, 11b, and 11c, respectively The gate 5a of the switch transistor 5 and the scan line 2 are made electrically conductive via the contact plug 20a. The drain electrode 5h of the switch transistor 5 and the signal line 3 are made electrically conductive via the contact plug 2a. Via the contact plug 20c, the source electrode 5i of the switch transistor 5 and the electrode 7a of the capacitor 7 are made electrically conductive, and the source electrode 5i of the switch transistor 5 and the gate 6a of the drive transistor 6 are made electrically conductive. Without the contact plugs 20a to 20c, the scan line 2 may come direct contact with the gate electrode 5a, the drain electrode 5h may come into contact with the signal line 3, and the source electrode 5i may come into contact with the gate electrode 6a.

The gate 6a of the drive transistor 6 is integrally linked to the electrode 7a of the capacitor 7, the drain electrode 6h of the drive transistor 6 is integrally linked to the voltage supply line 4, and the source electrode 6i of the drive transistor 6 is integrally linked to the electrode 7b of the capacitor 7.

The pixel electrode 8a is provided over the substrate 10 via the interlayer insulating film 11 and is formed independently in each pixel P. The pixel electrode 8a is a transparent electrode and is made of, for example, tin-dope indium oxide (ITO), zinc-doped indium oxide, indium oxide (In₂O₃), tin oxide (SnO₂), zinc oxide (ZnO), or cadmium-tin oxide (CTO) The pixel electrode 8a partially overlaps the source electrode 6i of the drive transistor 6, and the pixel electrode 8a and the source electrode 6i are connected to each other.

The pixel electrode 8a is washed and subject to plasma surface process so as to be lyophilic to a carrier transport layer to be applied on the pixel electrode 8a.

As shown in FIGS. 4 and 5, the interlayer insulatin 9 film 12 is formed so as to cover the scan line 2, the signal line 3, the voltage supply line 4, the switch transistor 5, the drive transistor 6, the periphery of the pixel electrode 8a, the electrode 7b of the capacitor 7, and the interlayer insulting film 11. In the interlayer insulating film 12, an opening 12a is formed so that the center portion of each of the pixel electrodes 8a is exposed. Consequently, the interlayer insulating film 12 is formed in a lattice shape in plan view.

A panel in which the scan line 2, the signal line 3, the voltage supply line 4, the switch transistor 5, the drive transistor 6, the capacitor 7, the pixel electrode 8a, and the interlayer insulating film 12 are formed on the surface of the substrate 10 serves as a transistor array panel.

As shown in FIGS. 4 and 5, the EL element 8 includes a pixel electrode 8a as a first electrode which is an anode, the hole injection layer 8b as a compound film formed on the pixel electrode 8a, the light emission layer 8c as a compound film formed on the hole injection layer 8b, and an opposite electrode 8d as a second electrode formed on the light emission layer 8c. The opposite electrode 8d is a single common electrode used for all of the pixels P and is formed continuously with respect to all of the pixels P.

The hole injection layer 8b is a function layer made of PEDOT (poly(ethylenedioxy)thiophene) as a conductive polymer and PSS (polystyrene sulfonate) as a dopant and for injecting holes from the pixel electrode 8a to the light emission layer 8c.

The light emission layer 8c is a layer including a material for emitting light of P (red), G (green), or B (blue) on the pixel P unit basis, made of, for example, a polyfluorene light emitting material or polyphenylenevinylene light emitting material, and emitting light when an electron supplied from the opposite electrode 8d and a hole injected from the hole injection layer 8b are recombined. Consequently, the light emitting material of the light emission layer 8c of the pixel P for emitting light of R (red), that of the pixel P for emitting liqht of C (green), and that of the pixel P for emitting light of B (blue) are different from each other. The pattern of P (red), G (green), and B (blue) of the pixels P may be a delta arrangement or a stripe pattern in which pixels of the same color are arranged in the vertical direction.

The opposite electrode 8d is made of a material having a work function lower than that of the pixel electrode 8a and is made of, for example, a single material or alloy including at least one of indium, magnesium, calcium, lithium, barium, and a rare-earth metal.

The opposite electrode 8d is a common electrode used for all of the pixels P and covers the bank 13 (which will be described later) and a compound film such as the light emission layer 8c.

Thus, the light emission layer 8c as a light emitting part is partitioned on a pixel to pixel basis by the interlayer insulating film 12 and the bank 13.

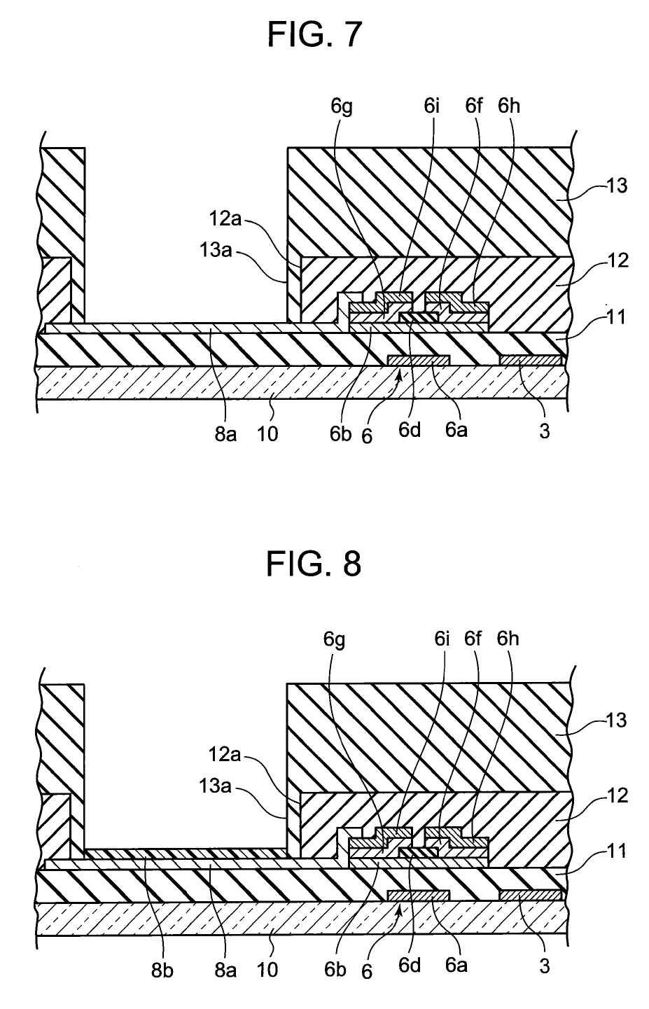

In the opening 13a, the hole injection layer 8b and the light emitting layer 8c as a carrier transport layer are stacked on the pixel electrode 8a (refer to FIGS. 7 to 9).

Concretely, when forming the hole injection layer 8b and the light emission layer 8c byawet process, the bank 13 functions as a partition wall so that liquid materials which are produced by dissolving or dispersing materials of the hole injection layer 8b and the light emission layer 8c in a solvent, do not seep into neighboring pixels P.

For example, as shown in FIG. 7, in the bank 13 provided on the interlayer insulating filn 12, the opening 13a is formed on the inner side of the opening 12a of the interlayer insulating film 12.

As shown in FIG. 8, a liquid material containing the material of the hole injection layer 8b is applied on the pixel electrodes 8a surrounded by the openings 13a, and a compound film formed by drying the liquid material by heating the substrate 10 becomes the hole injection layer 8b as a first carrier transport layer.

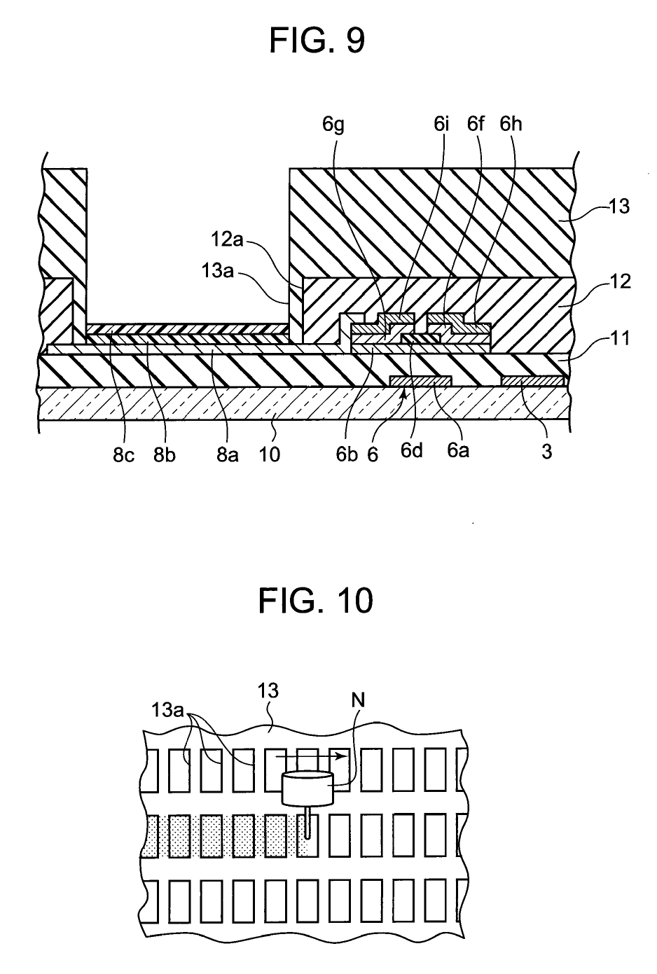

Further, as shown in FIG. 9, a liquid material containing the material of the light emission layer 8c is applied on the hole injection layers 8b surrounded by the openings 13a, and a compound film formed by drying the liquid material by heating the substrate 10 becomes the light emission layer 8c as a second carrier transport layer.

The opposite electrode 8d is provided so as to cover the light emission layer 8c and the bank 13 (refer to FIG. 5).

In the EL panel 1, the pixel electrode 8a, the substrate 10, and the interlayer insulating film 11 are transparent, and light emitted from the light emission layer 8c passes through the pixel electrode 8a, the interlayer insulating film 11, and the substrate 10 and goes out. Consequently, the rear face of the substrate 10 becomes the display surface.

Not the side of the substrate 10 but the opposite side may become the display surface. In this case, a transparent electrode is used as the opposite electrode 8d, a reflection electrode is used as the pixel electrode 8a, and light emitted from the light emission layer 8c passes through the opposite electrode 8d and goes out.

The EL panel 1 is driven and emits light as follows,

By sequentially applying voltage to the scan lines 2 by the scan driver in a state where voltage of predetermined level is applied to all of the voltage supply lines 4, the scan lines 2 are sequentially selected.

When a voltage of a level according to a tone is applied to all of the signal lines 3 by the data driver in a state where the scan lines 2 are selected, since a switch transistor 5 corresponding to the selected scan line 2 is on, the voltage of the level according to the tone is applied to the gate 6a of the drive transistor 6.

According to the voltage applied to the gate 6a of the drive transistor 6 the potential difference between the gate electrode 6a and the source electrode 6i of the drive transistor 6 is determined, the magnitude of drain-source current in the drive transistor 6 is determined, and the EL element 8 emits light with brightness according to the drain-source current.

After that, when the selection of the scan line 2 is cancelled, the switch transistor 5 is turned off. Consequently, charges according to the voltage applied to the gate 6a of the drive transistor 6a restored in the capacitor 7, and the potential difference between the gate electrode 6a and the source electrode 6i of the drive transistor 6 is held.

Therefore, the drive transistor 6 keeps on passing the drain-source current of the same current value as that at the time of the selection, and the brightness of the EL element 8 is maintained.

A method of manufacturing the EL element 8 in the EL panel 1 will now be described.

A gate metal layer is deposited on the substrate 10 by sputtering and patterned by photolithography to form the signal line 3, the electrode 7a of the capacitor 7, the gate 5a of the switch transistor 5, and the gate 6a of the drive transistor 6. After that, the interlayer insulating film 11 serving as a gate insulating film made of silicon nitride or the like is deposited by plasma CVD. In the interlayer insulating film 11, a contact hole (not shown) opened for an external connection terminal of a scan line 2 to be connected to a scan driver positioned in one side of the EL panel 1 is formed.

Subsequently, a semiconductor layer made of amorphous silicon or the like to become the semiconductor films 5b and 5b and an insulating layer made of silicon nitride or the like to become the channel protection films 5d and 6d are continuously deposited and, after that, the channel protection films 5d and 6d, are patterned by photolithography. An impurity layer to become the impurity semiconductor films 5f, 5g, 6f, and 6g is deposited. After that, the impurity layer and the semiconductor layer are continuously patterned by photolithography to form the impurity semiconductor films 5f, 5g, 6f, and 6g and the semiconductor films 5b and 6b.

The contact holes 11a to 11c are formed by photo lithograply. Subsequently, the contact plugs 20a to 20c are formed in the contact holes 11a to 11c, respectively. The process may be omitted.

A source/drain metal layer to become the drain electrode 5h and the source electrode 5i of the switch transistor 5 and the drain electrode 6h and the source electrode 6i of the drive transistor 6 is deposited and properly patterned, thereby forming the scan line 2, the voltage supply line 4, the electrode 7b of the capacitor 7, the drain electrode 5h and the source electrode 5i of the switch transistor 5, and the drain electrode 6h and the source electrode 6i of the drive transistor 6. After that, an ITO film is deposited and patternedt to form the pixel electrode 8a.

An insulating film is formed by vapor-phase growth so as to cover the switch transistor 5, the drive transistor 6, and the like and is patterned by photolithography, thereby forming the interlayer insulating film 12 having the opening 12a from which the center portion of the pixel electrode 8a is exposed. Together with the opening 12a, a plurality of contact holes are formed, for exposing an external connection terminal of the scan line 2, external connection terminals of the signal lines 3 for connection to the data driver positioned in one side of the EL panel 1, an external .connection terminal of the voltage supply line 4, which are not shown. Subsequently, a photosensitive resin such as polyimide is deposited and exposed to form the bank 13 having the lattice shape having the openings 13a from which the hole injection layer 8b on the pixel electrode 8a is exposed. At this time, the contact holes for the external connection terminals are exposed from the bank 13.

As shown in FIGS. 2, 4, 5, and 7, recesses surrounded by the bank 13 having the lattice shape from which the plurality of pixel electrodes 8a are exposed on the pixel P unit basis serve as the openings 13a, each of which is approximately rectangular in shape in plan view.

The plurality of openings 13a corresponding to the pixel electrodes 8a of the pixels P are arranged, for example, as shown in FIG. 10, in a grid shape while forming a line of recesses in the horizontal direction in which the plurality of openings 13a are arranged along the shorter direction of the opening 13a which is approximately rectangular in shape and forming a line of recesses in the vertical direction in which the plurality of openings 13a are arranged along the longitudinal direction (longer direction) of the opening 13a.

A plasma surface process is performed on the pixels P (the plurality of openings 13a corresponding to the pixel electrodes 8a and the bank 13). An example of the plasma process is a method of irradiating oxygen in the plasma state.

By applying liquid materials obtained by dissolving or dispersing materials of the hole inj ection layer 8b and the light emission layer 8c in a solvent to the opening 13a and drying the liquid material, the hole injection layer 8b and the light emission layer 8c as a carrier transport layer can be formed.

When applying the liquid material containing the material of the carrier transport layer to the openings 13a, after the substrate 10 is heated together with a stage on which the substrate 10 is mounted, as shown in FIG. 10, an applying process is executed by the nozzle printing method, of injecting a predetermined liquid material from a nozzle N while relatively moving at least one of the nozzle N and the stage on which the substrate 10 is mounted along the line of the recesses in the horizontal direction in which the plurality of openings 13a are arranged in the shorter direction of the openings 13a, each of which is approximately rectangular in shape, and continuously applying the liquid material to the plurality of openings 13a. For example, while moving the stage on which the substrate 10 is mounted along the shorter directior of the opening 13a by a not-shown stage moving apparatus so that the nozzle N moves above the plurality of pixels P arranged in the shorter direction, the liquid material is injected from the nozzle N to the plurality of pixels P in the shorter direction. After that, the nozzle N is moved in the longer direction by the nozzle moving apparatus so as to prepare for injection of the liquid material to the pixels P in the next row. While moving again the stage on which the substrate 10 is mounted in the direction opposite to the direction of last time along the shorter direction of the opening 13a by the stage moving apparatus, the liquid material is injected from the nozzle N onto the plurality of pixels P in the next row arranged in the shorter direction. The nozzle N does not inject separate droplets like in an ink-jet method but injects continuous liquid current. Consequently, the liquid material is applied not only to the recesses surrounded by the bank 13 but also on top surfaces of the bank 13 between the recesses of the openings 13a arranged in the shorter direction as shown in FIG. 10. On the other hand, the liquid material is not applied on top surfaces of the bank 13 between the recesses of the openings 13a in the longer direction.

The liquid material applied in the openings 13a sandwiching the bank 13 through the nozzle N which relatively moves along the shorter direction of the opening 13a which is approximately rectangular in shape is dried and formed as a compound film, thereby forming the hole injection layer 8b and the light emission layer 8c. Since the liquid material applied on the bank 13 flows in the openings 13a to the front or rear side in the moving direction of the nozzle N, when the liquid material is dried, the compound film is formed only in the openings 13a.

By forming the hole injection layer 8b in the opening 13a (refer to FIG. 8) and, after that, applying the liquid material of the light emission layer 8c into the opening 13a and drying it (refer to FIG. 9), a carrier transport layer made of two layers can be formed.

By forming the opposite electrode 8d on the surface of the bank 13 and the light emission layer 8c, the EL element 8 and the EL panel 1 are manufactured.

As described above, by continuously applying the liquid material of the carrier transport layer along the plurality of openings 13a while relatively moving the nozzle N along the line of the recesses in the horizontal direction in which the plurality of openings 13a are arranged in the shorter direction of the opening 13a which is approximately rectangular in shape, and drying the liquid material, the hole injection layer 8b and the light emission layer 8c can be formed with substantially the same film thickness.

The reason why the film thickness of the carrier transport layer (the hole injection layer 8b and the light emission layer 8c) can be made more uniform by continuously applying the liquid material along the plurality of openings 13a while relatively moving the nozzle N along the shorter direction of the opening 13a which is approximately rectangular in shape will be described.

In the process of performing the plasma surface process on the plurality of openings 13a corresponding to the pixel electrodes 8a, the bank 13 is also subjected to the plasma surface process and becomes lyophilic. Therefore, in the process of forming a film by drying the liquid material applied in the opening 13a in the bank 13, a compound film is formed, although slightly, also on the side wall face of the opening 13a in the bank 13. It is known that, consequently, a phenomenon (“soaking” phenomenon) occurs such that the liquid material climbs up along the wall face of the opening 13a and the film is formed, and thus the film thickness nearer to the wall face is larger than that in the center side of the recess. Soaking is a phenomenon in which ink is soaked up by capillary action.

To address the phenomenon, formation of the hole injection layer 8b and the light emission layer 8c having more uniform film thickness was examined.

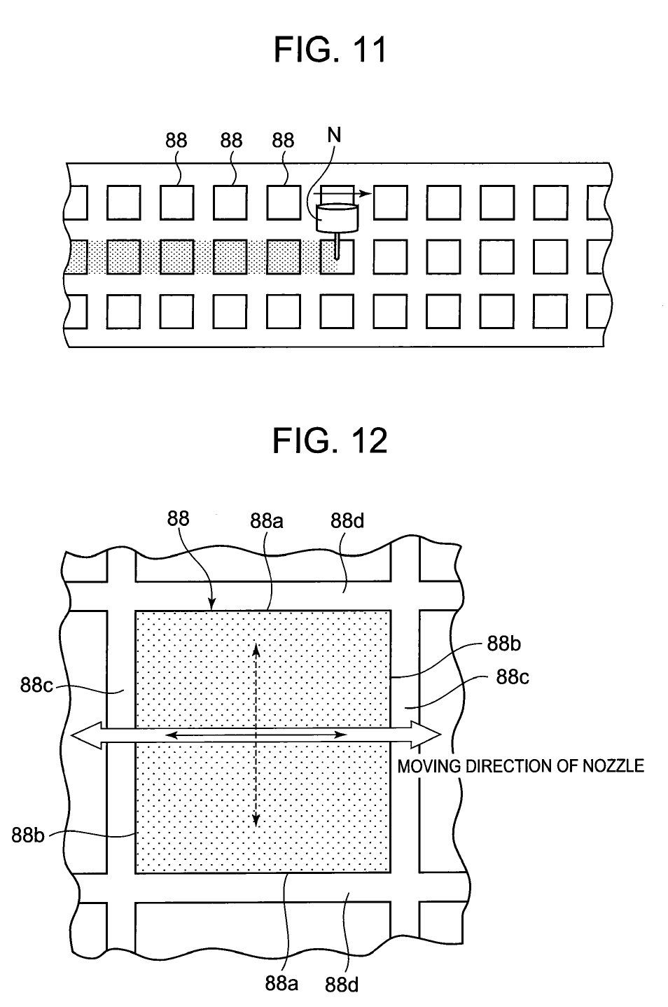

As shown in FIG. 11, while relatively moving the nozzle N along the line of recesses of a plurality of openings 88 partitioned by a predetermined partition wall (bank) made of a material similar to that of the bank 13, and each having an approximately square shape in plan view, a predetermined liquid material was injected from the nozze N and applied continuously along the plurality of openings 88. After that, the liquid material was dried to form a carrier transport layer. By measuring the film thickness of the carrier transport layer, measurement on the soaking exerting an influence on the film thickness was performed.

Concretely, using a liquid material obtained by diluting “BAYTRON P CH8000” made by Bayer asa liquid material containing the material (PEDOT/PSS) of the carrier transport layer (hole injection layer) with water to 709, under conditions that travel speed of the nozzle N is 2.5 m/sec, flow of the liquid material from the nozzle N is 96.28 μl/min, and the temperature is 40° C., the liquid material was continuously applied to the plurality of openings 88 along the line of the recesses of the openings 88 each having a square shape of 76 μm×76 μm and dried, thereby forming the hole injection layer as a part of the carrier transport layer in the openings 88.

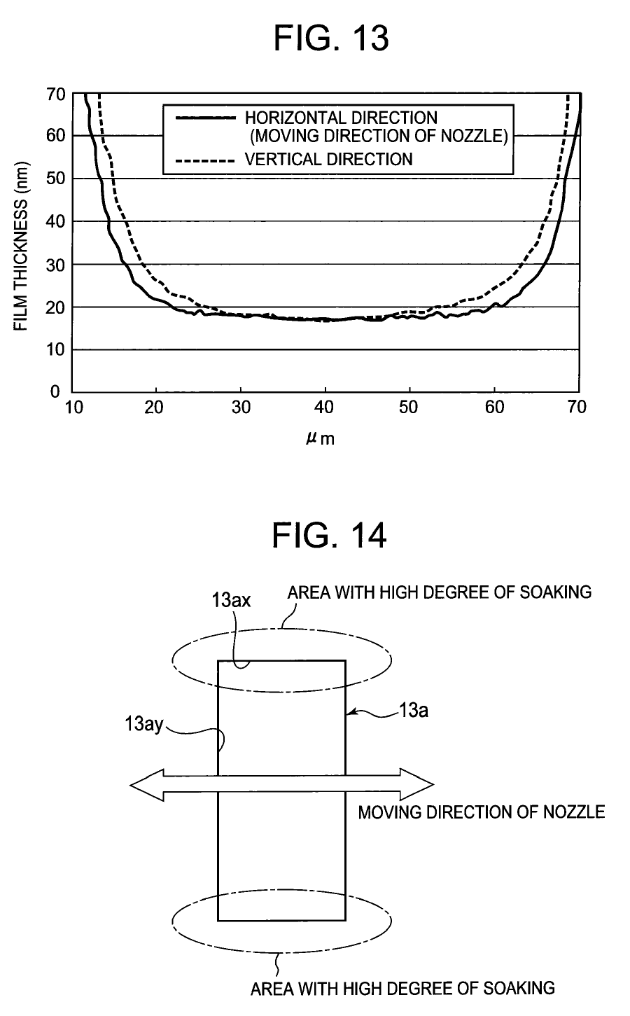

As shown iri FIG. 12, the film thickness in the horizontal direction along the moving direction of the nozzle N of the hole injection layer formed in the opening 88 and that in the vertical direction orthogonal to the moving direction of the nozzle N were measured. FIG. 13 shows the measurement result. The center in the horizontal direction and the center of the vertical direction correspond to 38 μm in the horizontal axis. 10 μm and 70 μm in the horizontal axis correspond to positions near the opening 88.

As shown in FIG. 13, with respect to the film thickness of the hole injection layer formed in the opening 88, a flat area having an approximately uniform thickness (film thickness of about 20 nm) in the horizontal direction along the moving direction of the nozzle N is larger than that in the vertical direction orthogonal to the moving direction of the nozzle N.

That is, in FIG. 12, the degree of soaking on the side of the upper and lower wall faces 88a along the moving direction of the nozzle N is higher than that on the side of the right and left wall faces 88b orthogonal to the moving direction of the nozzle N.

From the above, it can be said that, in the case of the opening 13a which is approximately rectangular in shape, as shown in FIG. 14, by applyinq a liquid material for forming the carrier transport layer while relatively moving the nozzle N in the direction along the shorter direction of the opening 13a and along the line of recesses of the plurality of openings 13a arranged in the shorter direction of the opening 13a, a larger flat part having an approximately uniform thickness can be formed while suppressing a part in which soaking occurs.

The phenomenon that the degree of soaking on the side of the upper and lower wall faces 88a is larger than that on the side of the right and left wall faces 88b in FIG. 12 will now be examined.

As shown in FIGS. 11 and 12, in the case of injecting a predetermined liquid material from the nozzle N while relatively moving the nozzle N along the line of the recesses of the plurality of openings 88 each having an approximately square shape, and continuously applying the liquid material to the plurality of openings 88, as shown in FIG. 11, the liquid material is applied on the bank between the recesses of the openings 88 arranged in the horizontal direction. Consequently, the liquid material is applied also on the bank regions 88c between the right and left wall faces 88b and 88b in FIG. 12 and a wet state is resulted. Since the liquid material applied on the bank flows in the opening 88 on the front or rear side in the moving direction of the nozzle N, the right and left wall faces 88b is wetter than the bank region 88d between the upper and lower wall faces 88a and 88a.

Above the bank region 88c, the vapor pressure of the solvent of the applied liquid material is locally high, and the temperature is slightly decreased by heat of evaporation of the solvent. Therefore, the bank region 88c is not easily dried. On the other hand, above the bank region 88d, since the liquid material is not applied, the vapor pressure of the solvent is locally low, and there is no factor of decreasing heat such as evaporation of the solvent. Consequently, the temperature above the bank region 88d is slightly higher than the bank region 88c, and the bank region 88d is dried more easily. As a result, in the process of drying the applied liquid material, the solvent is dried on the upper and lower wall faces 88a in the diagram on the bank region 88d side more easily than that on the right and left wall faces 88b in the diagram on the bank region 88c side. That is, progress of drying on the wall face 88a side in the opening 88 is faster than that on the wall face 88b side.

Therefore, since drying on the wall face 88a side in the opening 88 is faster, the liquid material is dried while being slightly flowed toward the wall face 88a in the drying process, and the film is formed under condition that the material corresponding to the solvent contained in the liquid material is easily deposited on the wall face 88a side. It can be therefore said that the film thickness on the wall face 88a side increases, and the degree of soaking on the wall face 88a side becomes larger.

As shown in FIG. 14, a part in which soaking is relatively large (that is, the length. of a side 13ax along the shorter direction of the opening 13a) is shorter than a part in which soaking is relatively small (that is, the length of a side 13ay along the longitudinal direction of the opening 13a). Thus, the degree of soaking can be reduced.

Actually, as shown in FIG. 10, a predetermined liquid material was injected from the nozzle N while relatively moving the nozzle N along the line of the plurality of openings 13a in the shorter direction of the openings l3a which is rectangular in shape, and the liquid material was continuously applied along the plurality of openings 13a. After that, the liquid material was dried. The film thickness of the carrier transport layer obtained in such a manner was measured.

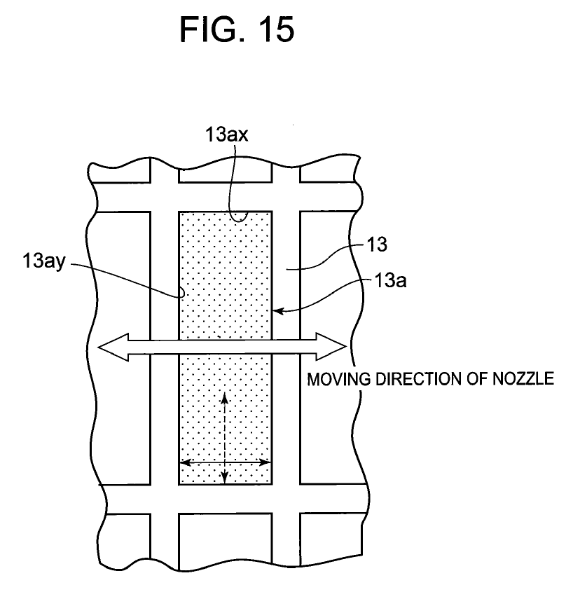

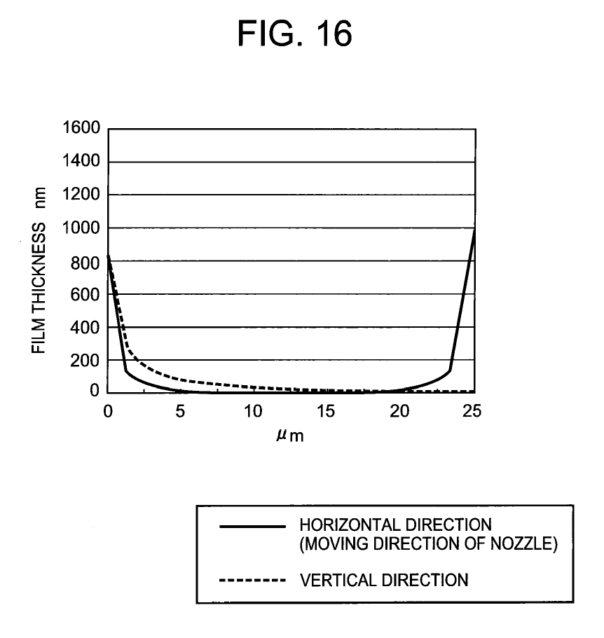

Concretely, as shown in FIG. 15, the opening 13a of the bank 13 has a rectangular shape of 75 μm×25 μm (long side 13ay×short side 13ax). Under conditions that the travel speed of the nozzle N is 2.5 m/sec, flow of the liquid material from the nozzle N is 83.35 μl/min, and the temperature is 40° C., a pixel P was subjected to O₂ plasma process (under conditions of using the barrel asher DES-106-254AEH made by Plasma System Company, the degree of vacuum of 0.5 Torr, RF output of 250 W, and O₂ flow of 60 sccm) for five minutes. The film thickness of a carrier transport layer formed by applying a liquid material containing PEDOT/PSS (for example, a liquid material obtained by diluting “BAYTPON P CH8000” made by Bayer with water to 70%) along the line of the recesses of the openings 13a and drying the liquid material was measured. FIG. 16 shows the measurement result.

As shown in FIG. 15, in the horizontal direction along the moving direction of the nozzle 15, the film thickness was measured in the range of 25 μm from an end of the opening 13a to the other end. In the vertical direction orthogonal to the moving direction of the nozzle N, the film thickness was measured in the range of 25 μm from an end of the opening 13a to the inside.

According to the actual measurement result shown in FIG. 16, the degree of soaking on the long side 13ay of the opening 13a is more reduced than that on the short side 13ax of the opening 13a, and flatness of the film thickness is kept high.

As described above, by applying the liquid material through the nozzle N which relatively moves in the shorter direction of the opening 13a having an approximately rectangular shape, the degree of soaking can be reduced, and the hole injection layer 8b and the light emitting layer 6c having more uniform thickness can be formed.

That is, by continuously applying the liquid material along the plurality of openings 13a while relatively moving the nozzle N along the line of the recesses in the horizontal direction in which the plurality of openings 13a are arranged in the shorter direction of the opening 13a having an approximately rectangular shape, the area of the flat part of the hole injection layer 8b and the light emission layer 8c in one pixel P is enlarged more than the case of applying the liquid material along the plurality of openings 13a while relatively moving the nozzle N along the line of recesses in the vertical direction in which the plurality of openings 13a are arranged in the longitudinal direction of the opening 13a having an approximately rectangular shape. Thus, the film thickness of the carrier transport layer (the hole injection layer 8b and the light emission layer 8c) can be made more uniform.

Since the degree of soaking is reduced, a major part of the applied liquid material can be efficiently formed as a flat film of the carrier transport layer (the hole injection layer 8b and the light emission layer 8c). Thus, the film thickness of the carrier transport layer to be formed is more easily controlled and adjusted. Further, the film thickness of the flat film portion in the carrier transport layer tends to increase because the degree of soaking is low. Accordingly, the amount of the liquid material used for obtaining a predetermined thickness can be more reduced than that in the conventional technique.

The more the flim thickness of the hole injection layer 8b and the light emission layer 8c as the carrier transport layer is uniform, the more the luminance efficiency of the carrier transport layer improves, and excellent light emission is performed. Thus, by forming the hole injection layer 8b and the light emission layer 8c having a preferable thickness, the EL element 8 realizing excellent light emission can be manufactured.

In the case of a full-color EL panel having red pixels (R), green pixels (G), and blue pixels (B) obtained by sequentially repetitively providing a carrier transport layer of red, a carrier transport layer of green, and a carrier transport layer of blue along the shorter direction of the opening 13a having an approximately rectangular shape, a liquid material for the light emission layers corresponding to the colors R, G, and B may be applied while relatively moving the nozzle N along the line of the recesses in the vertical direction along the longitudinal direction of the opening 13a having an approximately rectangular shape, thereby forming the line of the light emission layers Bc for emitting red light, the line of the light emission layers 8c for emitting green light, and the light emission layers 8c for emitting blue light along the vertical direction.

In this case, it is preferable to form each carrier transport layer having uiniform thickness by reducing the degree of soaking in such a manner that only a liquid material, which is produced by dissolving or dispersing a material of a light emission layer 8c of each color in a solvent, is applied along the longitudinal direction of the openings 13a, each of which has an approximately rectangular shape, and a liquid material containing the material of the carrier injection layer such as the hole injection layer 8b is applied along the shorter direction of the openings 13a, each of which has an approximately rectangular shape.

In the foregoing embodiments, the carrier transport layer which is made of two layers (the hole injection layer 8b as a carrier injection layer and the light emission layer 8c) has been described as an example. However, the invention is not limited to the example. For example, an EL element having a carrier transport layer made of a single light emission layer, or a carrier transport layer made of three or more layers including an electron injection layer in addition to the hole injection layer as the carrier injection layer may also be employed.

Although the plurality of carrier transport layers are formed by a wet film forming method in the foregoing embodiments, if at least one layer is formed by the wet film forming method, the above-described effects can be achieved. For example, it is also possible to form the hole injection layer 8b by a non-wet film forming method (e.g. evaporating or sputtering a material containing a metal oxide), and form the light emission layer 8c by the wet film forming method (e.g. applying a compound liquid material).

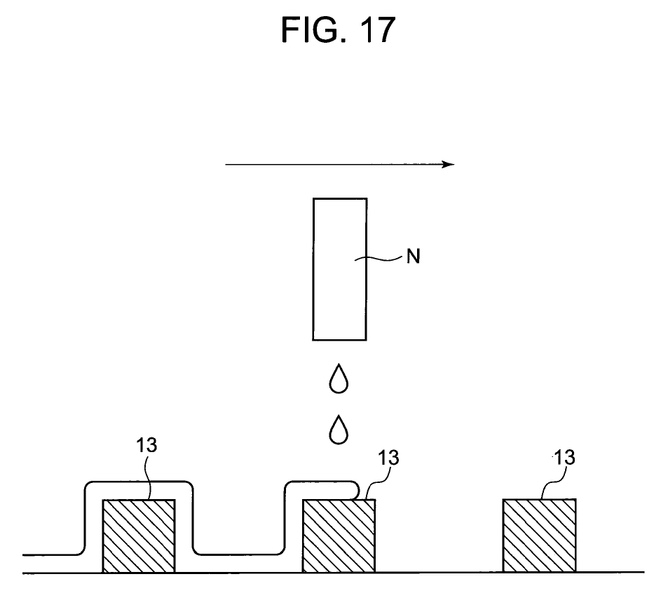

Although the nozzle printing method is employed in the foregoing embodiments, as shown in FIG. 17, droplets may be injected by an inkjet method not only onto pixels but also onto the bank 13 along the shorter direction of the pixels. In this case, the droplets may be injected continuously to prevent the droplets on the pixels and on the bank 13 from being dried.

It will be apparent to those skilled in the art that various modification and variation can be made in the concrete detailed structures without departing from the scope of the invention.

The entire disclosure of Japanese Patent Application No. 2008-62678 filed on Mar. 12, 2008 and Japanese Patent Application No. 2008-334243 filed on Dec. 26, 2008 each including description, claims, drawings, and abstract are incorporated herein by reference in their entireties.

Although various exemplary embodiments have been shown and described, the invention is not limited to the embodiments shown. Therefore, the scope of the invention is intended to be limited solely by the scope of the claims that follow.

What is claimed is:

1. A method of manufacturing an EL element, the EL element comprising:
a first electrode formed on a substrate;
a carrier transport layer formed on the first electrode;
a second electrode formed on the carrier transport layer; and
a partition wall by which an opening is defined, the partition wall including a side wall in a longer direction of the opening and a side wall in a shorter direction of the opening, the opening being formed by surrounding the first electrode by the side wall in the longer direction and the side wall in the shorter direction, and
the method comprising:
moving a nozzle relatively along the shorter direction of the opening; and
applying a liquid material, which is produced by dissolving or dispersing a material of the carrier transport layer in a solvent, to the first electrode in the opening to produce an applied liquid material by injecting the liquid material from the nozzle.

2. The method of manufacturing an EL element according to claim 1, wherein
the liquid material is further applied onto a top surface of the side wall in the longer direction, the side wall being adjacent to the opening along the shorter direction.

3. The method of manufacturing an EL element according to claim 1, wherein
the carrier transport layer includes a light emission layer for emitting light and a carrier injection layer for injecting a carrier into the light emission layer, and
in the step of applying the liquid material, the liquid material which is produced by dissolving or dispersing a material of at least the carrier injection layer in a solvent, is applied to the first electrode.

4. The method of manufacturing an EL element according to claim 1, wherein
the carrier transport layer includes a light emission layer for emitting light and a carrier injection layer for injecting a carrier into the light emission layer,
the carrier injection layer is formed by a non-wet film forming method, and
the light emission layer is formed in the step of applying the liquid material.

5. The method of manufacturing an EL element according to claim 1, further comprising:
drying the applied liquid material after the step of applying the liquid material.

6. The method of manufacturing an EL element according to claim 5, further comprising:
forming the second electrode covering the carrier transport layer and the partition wall after the step of drying the applied liquid material.

7. The method of manufacturing an EL element according to claim 1, wherein
in the step of applying the liquid material, the liquid material is applied by a nozzle printing method.

8. The method of manufacturing an EL element according to claim 1, wherein
in the step of applying the liquid material, the liquid material is applied by an ink-jet method.

9. A method of manufacturing an EL panel having partition walls by which a plurality of electrodes on a substrate are surrounded,
a plurality of openings being defined by the partition walls, each of the partition walls including a side wall in a longer direction of each opening and a side wall in a shorter direction of each opening, each opening being formed by surrounding each electrode by the side wall in the longer direction and the side wall in the shorter direction, and
the method comprising:
moving a nozzle relatively along a line of the openings arranged in the shorter direction; and
continuously applying a liquidmaterial, which is produced by dissolving or dispersing a material of a carrier transport layer in a solvent, to the plurality of the openings to produce an applied liquid material by injecting the liquid material from the nozzle.

10. The method of manufacturing an EL panel according to claim 9, wherein
the carrier transport layer includes a light emission layer for emitting light and a carrier injection layer for injecting a carrier into the light emission layer, and
in the step of applying the liquid material, the liquid material which is produced by dissolving or dispersing a material of at least the carrier injection layer in a solvent, is applied.

11. The method of manufacturing an EL panel according to claim 9, wherein
the carrier transport layer includes a light emission layer for emitting light and a carrier injection layer for injecting a carrier into the light emission layer,
the carrier injection layer is formed by a non-wet film forming method, and
the light emission layer is formed in the step of applying the liquid material.

12. The method of manufacturing an EL panel according to claim 9, wherein
the liquid material is not applied onto top surfaces of the partition walls between the openings which areadjacent along the longer direction.

13. The method of manufacturing an EL panel according to claim 9, wherein
the liquid material is further applied onto a top surface of the side wall in the longer direction between the openings.

14. The method of manufacturing an EL panel according to claim 9, further comprising:
drying the applied liquid material after the step of applying the liquid material.

15. The method of manufacturing an EL panel according to claim 14, further comprising:
forming a second electrode covering the carrier transport layer and the partition walls after the step of drying the applied liquid material.

16. The method of manufacturing an EL panel according to claim 9, wherein
in the step of applying the liquid material, the liquid material is applied by a nozzle printing method.

17. The method of manufacturing an EL panel according to claim 9, wherein
in the step of applying the liquid material, the liquid material is applied by an ink-jet method.
